(19) United States
(12) Patent Application Publication
(10) Pub. No.: US 2015/0135924 A1
(43) Pub. Date: May 21, 2015

(54) CUTTING TOOL

(71) Applicant: Charlie ZHANG, Oak Brook, IL (US)

(72) Inventor: Charlie ZHANG, Oak Brook, IL (US)

(21) Appl. No.: 14/082,772

(22) Filed: Nov. 18, 2013

(51) Int. Cl. B26D 5/16; B26D 1/08

(52) U.S. Cl. CPC B26D 5/16; B26D 1/08; B26D 2001/004
USPC 83/628

(57) ABSTRACT

A cutting tool for cutting building materials, such as vinyl and PVC flooring, in a straight and predicable manner using an arc cutting motion. The cutting tool utilize a cam to force a pivot connected blade holder with a blade downward through a piece of building material placed under the blade.

### BACKGROUND OF THE INVENTION

1. Field of the Invention

This invention relates to a cutting tool for cutting building materials, for example vinyl or polyvinyl chloride (PVC) flooring. More specifically, this invention relates to a cutting tool including a base with a pair of support supporting a cam rotatably connected to the pair of supports and a blade holder with a blade, the blade holder pivotally connected to the pair of supports to move in an arc and movable downward by rotating the cam.

2. Discussion of Related Art

Various tools are currently used to cut building materials, however most are bulky, heavy, require power to be operated, produce large amounts of dust during the cutting process, and/or result in uneven or splintered cuts. Accordingly, there is a need for an improved cutting tool for cutting building materials. There is a need for a portable, non-power operated cutting tool capable of cutting building materials, particularly vinyl and PVC flooring, in a predictable and straight fashion without splintering, cracking or similar problems and without creating dust.

### SUMMARY OF THE INVENTION

The present invention provides a portable, non-power operated cutting tool for cutting sheets of building materials, for example, but not limited to, vinyl and polyvinyl chloride (PVC) flooring, in a clean, straight manner without tearing, splintering or cracking.

According to an embodiment of this invention, the cutting tool includes a base with a support surface for supporting the building material that is to be cut. The support surface preferably further includes a guide rail for aligning the material. The guide rail may be adjustable, allowing the building material to set at a range of angles to the blade in a horizontal plane. The base further includes a pair of supports extending vertically from the base. The supports are preferably positioned on either side of the base with a blade holder and a cammed axle extending between the supports.

The blade holder is preferably connected with a pivot connection to the supports and spaced from the support surface to allow the building material to slide under the blade holder. In a preferred embodiment, the blade holder includes a main body with arm extending from the main body. The main body preferably includes a slot with a threaded connection for connecting a blade to the blade holder. The threaded connection allows for the blade to be removed for replacement or repairs. Alternatively, the blade may be connected with any type of connection, such as an adhesive or weld connection. In another embodiment, the blade holder and the blade may be integrally formed together. The arm extends from the main body and includes a connection for a pivot connection to the pair of supports. In a preferred embodiment, the connection comprises an axle connection between each support and each arm. With the axle connection the blade moves in an arc, where the arc includes a radius equal to a distance between the axle and the blade. The circular motion of the arc improves the ability of the cutting tool to cut through building materials such as vinyl and PVC flooring.

The cammed axle is rotatably connected to the supports and positioned over and in contact with the blade holder. The blade holder and the blade are moveable between an open position, where the blade is separated from the base, and a closed position, where the blade is in contact or nearly contacting the base, by rotating the cammed axle. In the open position, the cammed axle contacts the blade holder at a relatively small radius of the cam, as the cam rotates, the cammed axle contacts the blade holder at a gradually increasing radius forcing the blade holder downward until the blade contacts a blade stop, the closed position. In a preferred embodiment, a spring is positioned between the base and the blade holder. The spring biases the blade holder in the open position and is compressed as the blade holder moves downward. In a preferred embodiment, a handle is connected to the cammed axle to assist in rotating the cam.

### BRIEF DESCRIPTION OF THE DRAWINGS

FIG. 1 is a perspective view of a cutting tool in a closed position according to one embodiment of this invention.

FIG. 2a is a side view of the cutting tool shown in FIG. 1 in an open position.

FIG. 2b is a close-up of the side view shown in FIG. 2a with elements of the cutting tool removed for explanatory purposes.

FIG. 3a is a side view of the cutting tool shown in FIG. 1 in the closed position.

FIG. 3b is a close-up of the side view shown in FIG. 3a with elements of the cutting tool removed for explanatory purposes.

FIG. 4a is a rear view of the cutting tool shown in FIG. 1 in the closed position.

FIG. 4b is a rear view of the cutting tool shown in FIG. 1 in the open position.

FIG. 5 is a top view of the cutting tool shown in FIG. 1.

FIG. 6 is a bottom view of the cutting tool shown in FIG. 1.

### DESCRIPTION OF THE INVENTION

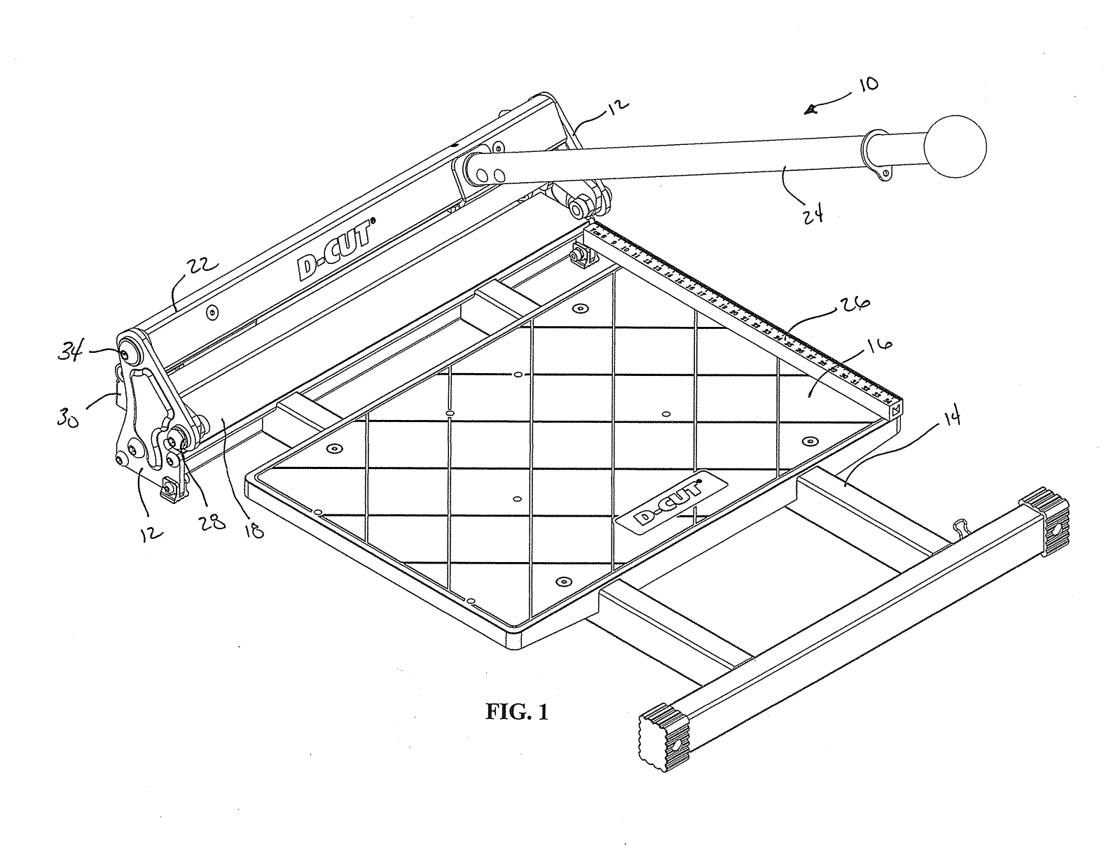

FIG. 1 shows a perspective view of a cutting tool 10 according to one embodiment of this invention. The cutting tool 10 as described is preferably used to cut building materials, not shown, such as, but not limited to, vinyl and PVC flooring materials. The cutting tool 10 utilizes an arc cutting motion which easily severs the building material and prevents damaging the building materials during cutting.

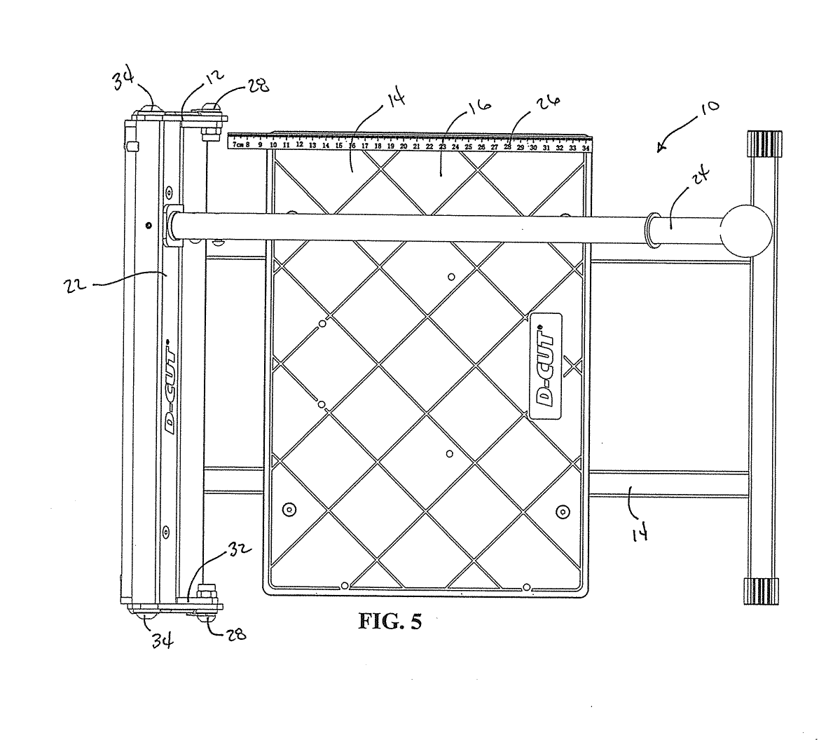

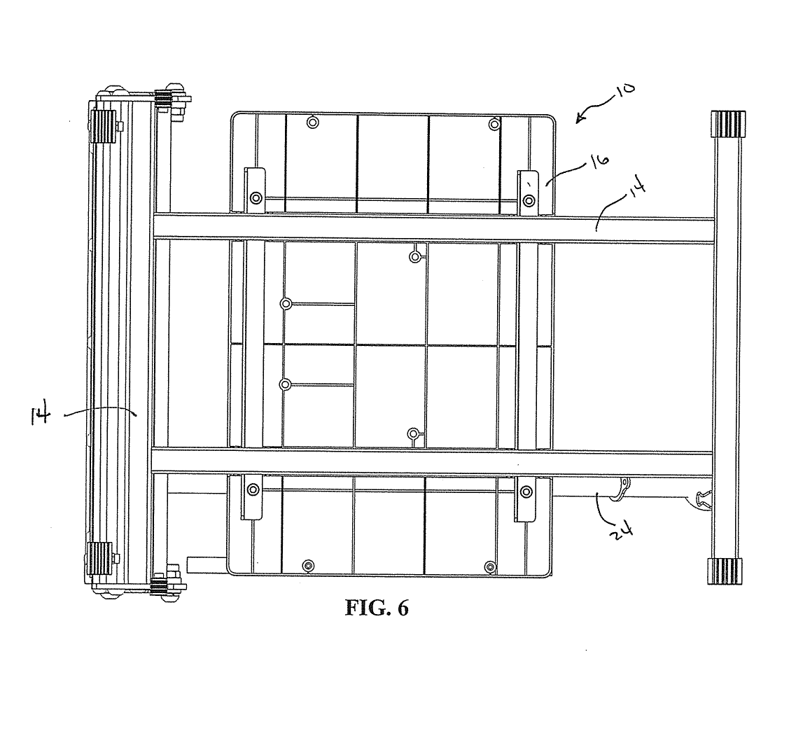

As shown in FIGS. 1-6, the cutting tool 10 includes a base 14, a support surface 16, a pair of supports 12, a blade holder 18, blade 20, and a cam 22 with a handle 24. As best shown in FIG. 6, the base 14 comprises an “I” shape with cross braces to provide rigidity and stability for the cutting tool 10, however the base 14 is not limited to this shape and may comprises any shape that provides a stable base for the cutting tool 10. The base 14 may be formed of steel, aluminum or another material with durable qualities capable of withstanding the force required to cut the building materials.

In an embodiment, the support surface 16 is mounted on the base 14 with threaded connections. In an alternative embodiment the support surface 16 and the base 14 may be integrally formed as a single component. The support surface 16 preferably includes a textured or a high friction, non-slip surface that prevents the building material from slipping or moving during cutting process. The support surface 16 is preferably made of lightweight and durable materials, such as plastic, rubber, metal and composite materials, but may be made of any material capable of supporting the building materials and withstanding the cutting force. The base 14 and support surface 16 are preferably sized to accommodate standard sizes of materials, such as a vinyl and PVC flooring tiles, and may correspond in width to such materials.

The support surface 16 preferably includes a guide rail 26 on support surface 16 that can be used to align the building materials to the blade 20. In an alternative embodiment, the guide rail 26 may be adjustable to cut the material at a range of angles to the blade 20. The guide rail 26 may further include a ruler for measuring the material to be cut.

In a preferred embodiment of this invention, the pair of supports 12 are connected to the base 14 and extend generally perpendicular to a plane of the support surface 16. In this embodiment, the pair of supports 12 are connected to the base with a threaded connection and are positioned on either side of the base 12 at a width sufficient to accommodate the material to be cut. The pair of supports 12 may be formed of durable materials such as, but not limited to, steel, aluminum or similar rigid materials which are capable of withstanding the force created during cutting. In other embodiments, the pair of supports 12 can be welded to or integrally formed to the base 14 or connected in any other means known to one of skill in the art.

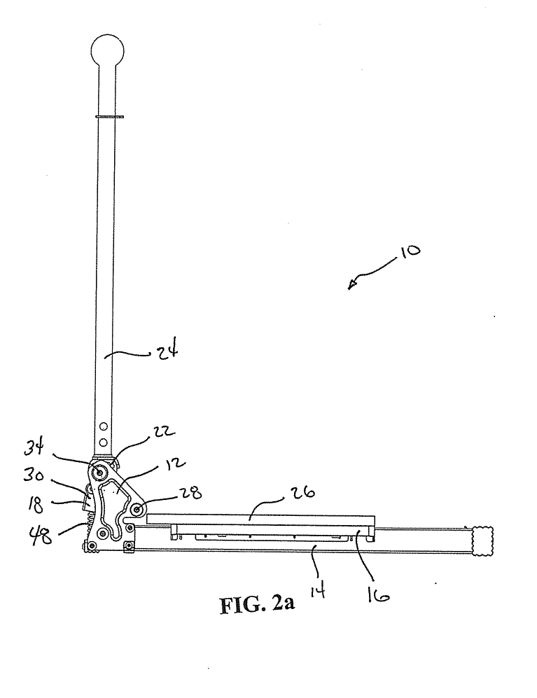

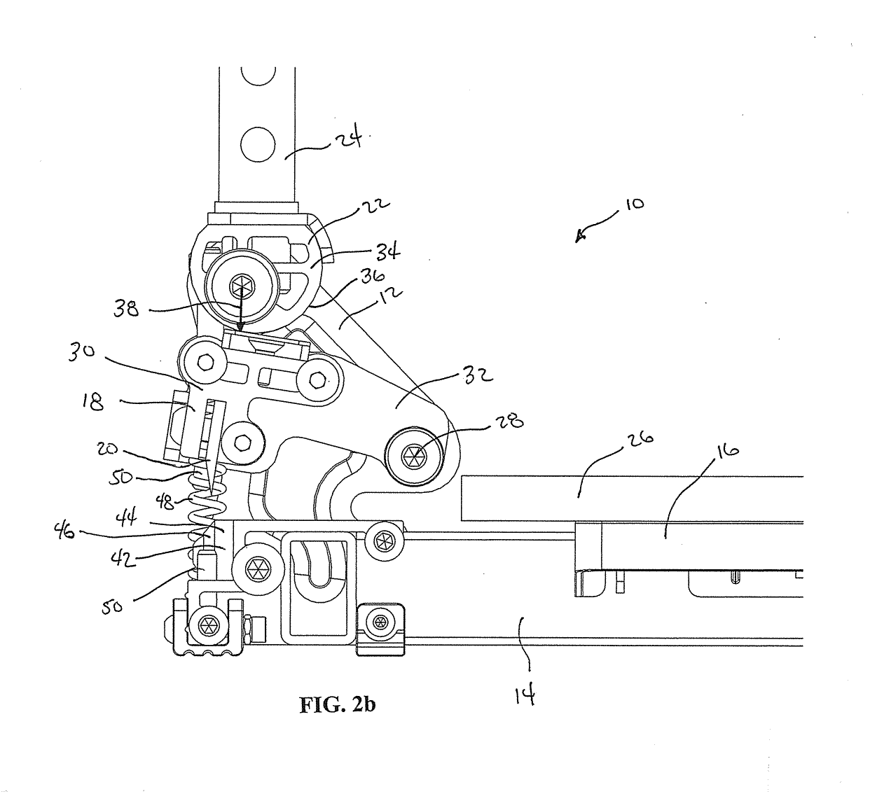

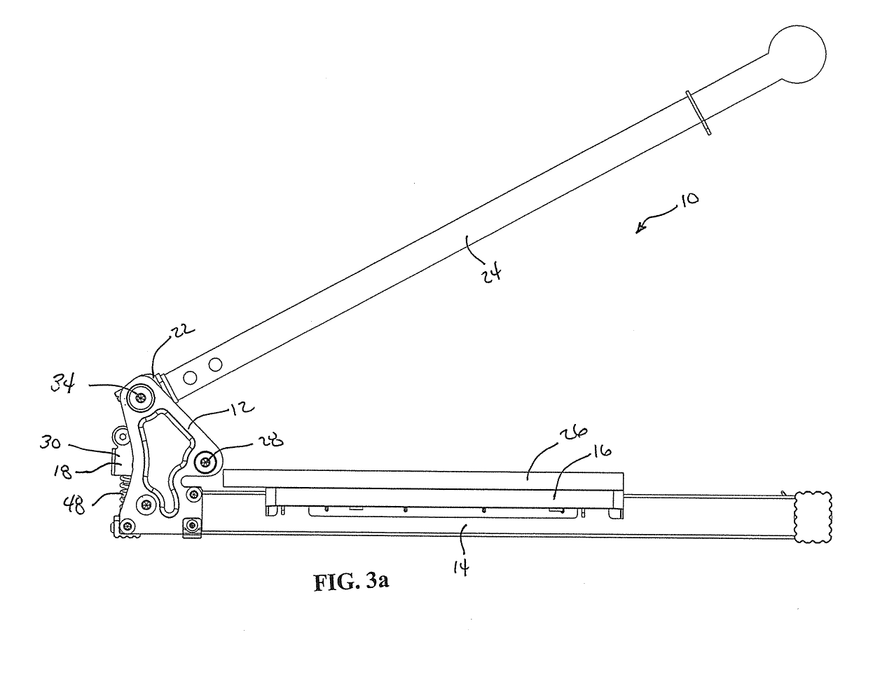

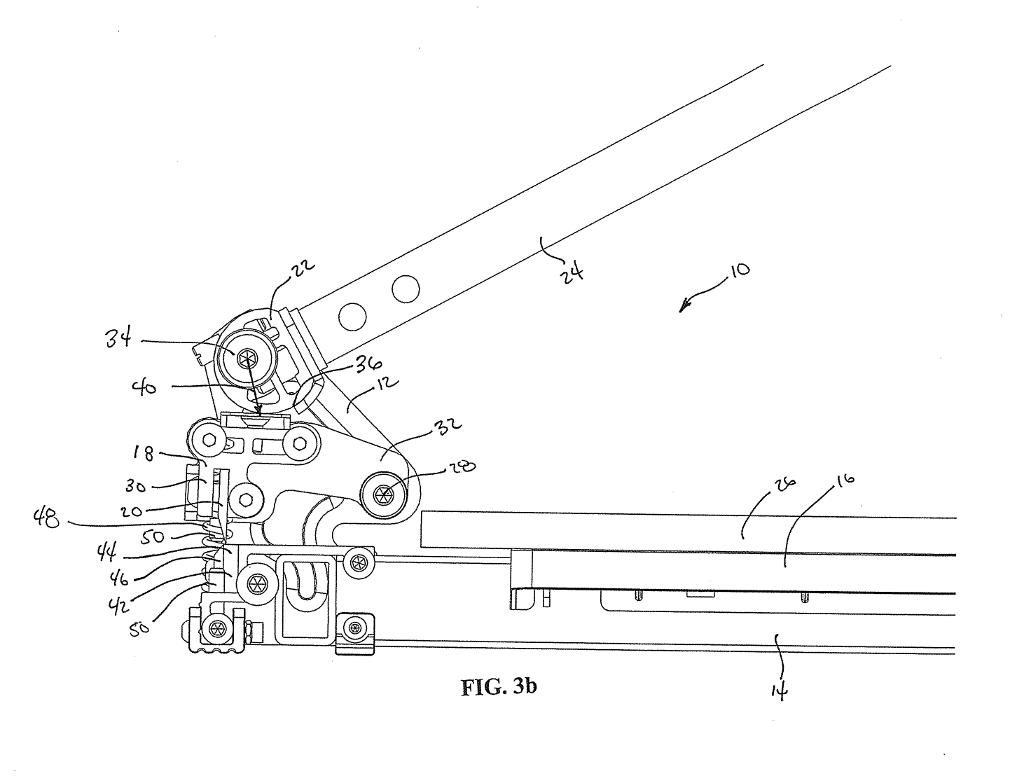

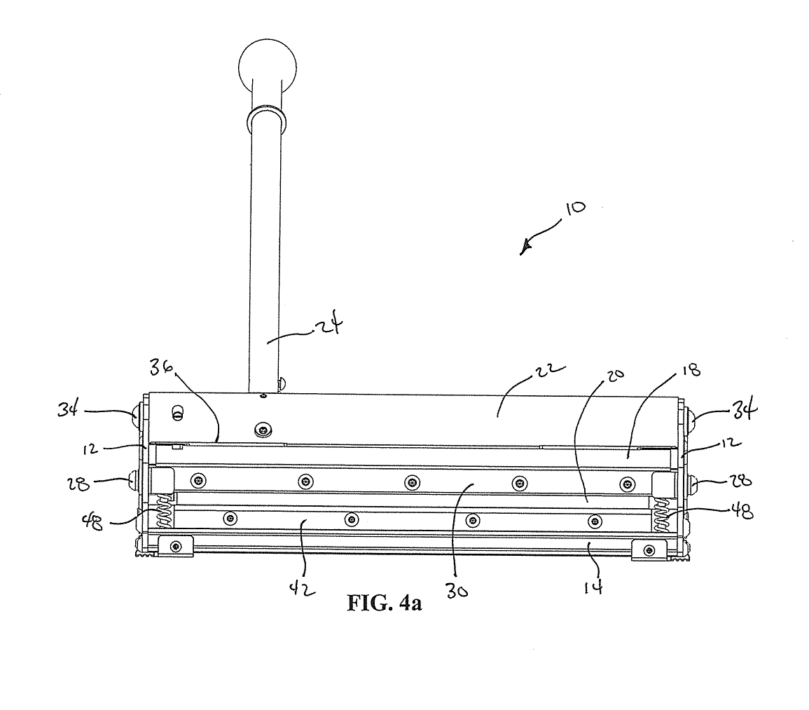

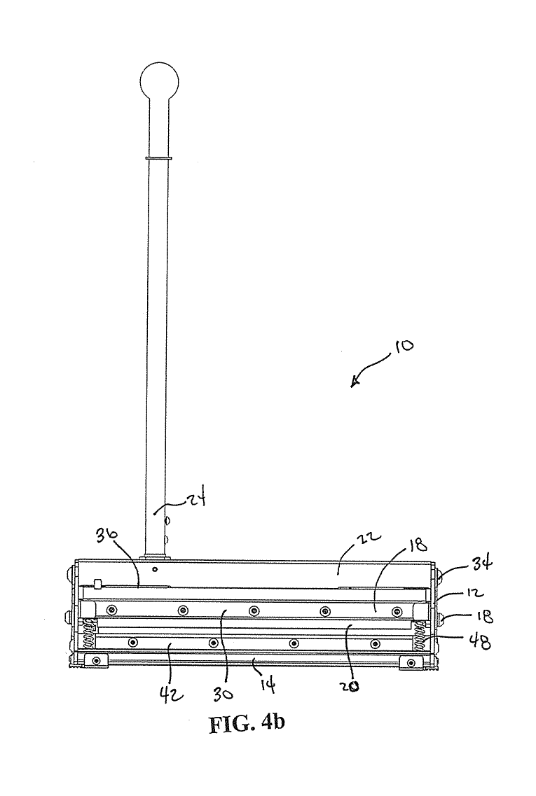

As best shown in FIGS. 4a-b, the blade holder 18 is positioned between the pair of supports 12 and below the cam 22 with a blade holder pivot connection 28 which allows the blade holder 18 to move in an arc pattern from the open position to the closed position. As best shown in FIGS. 2b and 3b, the blade holder 18 includes a main body 30 and an arm 32 extending from the main body 30. The blade holder pivot connection 28 preferably comprises an axle which extends through a distal end of the arm 32 opposite the blade 20 and through the support 12. In this embodiment, the axle comprises a pair of axles, one for each of the supports 12. Alternatively, the axle may comprise a single axle extending through the arm of the blade holder 18 and both pairs of supports 12. In a preferred embodiment, the blade 20 moves in an arc pattern having a radius of the distance between the blade 20 and the blade holder pivot connection 28. This arc pattern provides a clean cut through various building materials, especially vinyl and PVC flooring. The blade holder 18 may be formed of durable materials such as, but not limited to, steel, aluminum or similar rigid materials which are capable of withstanding the force created during cutting.

In a preferred embodiment, the blade 20 is attached to the blade holder 18 with a threaded connection. With this arrangement, the blade 20 can be removed from the blade holder 18 for repairs, sharpening and to select a specialty blade for a type of material. In an alternative embodiment, the blade 20 can be integrally formed with the blade holder 18. The blade 20 is preferably formed of steel or another material capable of repeatedly cutting the building material.

As shown in FIGS. 4a-b, the cam 22 is positioned between the pair of supports 12 and over and in contact with the blade holder 18. In a preferred embodiment of the invention, the cam 22 contacts the blade holder 18 in proximity to the blade 20. The cam 22 preferably includes an axle 34 which extends through the pair of supports 12 to provide a rotatable connection between the cam 22 and the supports 12. Alternatively, any type of connection may be used to provide a rotatable connection. As best shown in FIGS. 2b and 3b, the cam 22 includes a cam edge 36 with a gradually increasing radius from a small radius 38 to a large radius 40. As the cam 22 rotates, the increasing radius of the cam edge 36 forces the blade holder 18 downwards from the open position, see FIG. 2b, to the closed position, see FIG. 3b. In an embodiment, at least one of the cam 22 and the blade holder 18 may include a low friction durable surface to minimize the friction between the cam 22 and the blade holder 18, as the cam is rotated. In another embodiment, a bearing or other low-friction device may be used.

In a preferred embodiment, the cutting tool includes the handle 24 which is connected to the cam 22 to assist a user to rotate the cam 22. A distal end of the handle 24 preferably includes a hand grip for the user to manually grab or engage. In an alternative embodiment, the handle 24 may be adjustable and/or extendible to provide additional assistance to cut through tough-to-cut materials.

In an embodiment of this invention, as shown in FIGS. 2b and 3b, the base 14 may include a blade stop 42 with a contact element 44 and a brace 46. The contact element 44 is preferably manufactured of a softer material that causes minimal damage to an edge of the blade 20 such as, but not limited to, nylon. The brace 46 is preferably manufactured of a durable material such as, but not limited to, steel and aluminum. Preferably, the contact element 44 and the brace 46 are connected to the base 14 with a threaded connection that allows the contact portion 44 to be easily replaced as it wears. In an alternative embodiment, the blade stop and the contact element may be manufactured from a durable material such as, but not limited to, steel and aluminum to withstand the impact of the blade.

According to a preferred embodiment, the blade holder 18 is biased upward into the open position by a spring 48. As shown in the figures, the spring 48 is positioned between the base 14 and the blade holder 18 and maintained in position with a pair of alignment pins 50. The strength and configuration of the spring 48 may be adjusted depending on the desired application.

In operation, the cutting tool 10 of this invention starts in the open position as shown in FIGS. 2a-b and 4b. In the open position, the spring 48 biases the blade holder 18 and the blade 20 upward and the cam 22 contacts the blade holder 18 at the relatively small radius 38, this provides an opening between the blade 20 and the blade stop 42 of the base 14. The material to be cut is placed onto the support surface 16 of the base 14 and through the opening formed between the blade 18 and the blade stop 42. To cut the material, the handle 24 is lowered to rotate the cam 22. By rotating the cam 22, a gradually increasing radius of the cam edge 36 pushes the blade holder 18 and blade 20 downward through the material until the relatively larger radius 40 of the cam 22 contacts the blade holder 18 and the blade 20 contacts the blade stop 42 thereby severing the material. The resulting cut is optimally free of splinters and a resulting cut end of the material is otherwise clean and straight.

While in the foregoing specification this invention has been described in relation to certain preferred embodiments thereof, and many details have been set forth for purpose of illustration, it will be apparent to those skilled in the art that the material cutter is susceptible to additional embodiments and that certain of the details described herein can be varied considerably without departing from the basic principles of the invention.

What is claimed is:

1. A cutting tool for cutting building material, the cutting tool comprising:
a base including a support surface;
a pair of supports extending vertically from the base;
a cam rotatably connected to the pair of supports with a handle extending from the cam;
a blade holder with a blade pivotally connected to the pair of supports and positioned under at least a portion of the cam, where the blade holder and the blade are movable between an open position and a closed position by rotating the cam, and wherein the blade moves in an arc from the open to the closed position.

2. The cutting tool of claim 1, wherein the blade holder includes an arm extending from a main body of the blade holder and a pivot point of the blade holder extends through the arm.

3. The cutting tool of claim 2, wherein the blade is removably connected to the main body.

4. The cutting tool of claim 1, further comprising:
a spring positioned between the blade holder and the base, the spring biasing the blade holder to the open position.

5. The cutting tool of claim 1, further comprising:
a guide rail positioned on the support surface.

6. The cutting tool of claim 1, further comprising:
a low-friction material positioned on at least one of the cam and the blade holder.

7. A cutting tool for cutting building materials, the cutting tool comprising:
a base having a pair of supports extending perpendicular from a surface of the base;
an axle with a cammed surface rotatably connected to the pair of supports, the cammed surface including a gradually increasing radius from a small radius to a large radius; and
a blade holder with a blade, the blade holder pivotally connected to the pair of supports and the blade holder positioned under at least a portion of the cammed surface of the axle, wherein the blade holder and the blade move in an arc to an open position to a closed position, wherein the blade holder and the blade are in the open position when the small radius of the cammed surface contacts the blade holder and wherein the blade holder and the blade are in the closed position when the large radius of the cammed surface contacts the blade holder.

8. The cutting tool of claim 7, wherein the blade holder includes an arm extending from a main body of the blade holder, the blade holder is and a pivot point of the blade holder extends through the arm.

9. The cutting tool of claim 8, wherein the blade is removably connected to the main body.

10. The cutting tool of claim 7, further comprising:
a handle connected to the axle for rotating the axle.

11. The cutting tool of claim 7, further comprising:
a spring positioned between the blade holder and the base, the spring biasing the blade holder to the open position.

12. The cutting tool of claim 7, further comprising:
a guide rail positioned on the base.

13. The cutting tool of claim 7, further comprising:
a low-friction material positioned on at least one of the cam and the blade holder.
